(19) United States
(12) Patent Application Publication
(10) Pub. No.: US 2009/0037225 A1
(43) Pub. Date: Feb. 5, 2009

(54) SYSTEM FOR INTEGRATED BUSINESS MANAGEMENT

(75) Inventors: Arnold E. Burchianti, II, Mars, PA (US); Greg Teamann, Mars, PA (US)

Correspondence Address: COHEN & GRIGSBY, P.C., 625 LIBERTY AVENUE, PITTSBURGH, PA, 15222-3152, US

(73) Assignee: Celtic Healthcare, Inc., Mars, PA (US)

(21) Appl. No.: 12/235,190

(22) Filed: Sep. 22, 2008

Related U.S. Application Data
(63) Continuation-in-part of application No. 12/115,018, filed on May 5, 2008.
(60) Provisional application No. 60/915,984, filed on May 4, 2007.

(51) Int. Cl. G06Q 50/00; G06Q 10/00

(52) U.S. Cl. 705/3; 705/8

(57) ABSTRACT

A computer-implemented system and method for managing and delivering workflow to a home healthcare service is disclosed. A processing interface is configured to communicate with and receive a request from an application. A request interpretation component converts the request to a standard format and a response formatting component is configured to convert a response to a format that a requesting application is configured to understand. Modules process the request to generate a response and to further process workflow resulting from the response or the request to generate workflow result. A storage platform stores the request, workflow, and workflow result.

### FIELD

The disclosure relates to an integrated system for managing and delivering workflow and documents related to providing home healthcare services, and particularly to an integrated system that tracks and processes information at various levels of providing the home healthcare services.

### BACKGROUND

Business systems that are currently known and available rely heavily on manual reporting processes to transfer information between departments and providers of the service. Alternative systems store some required documents electronically, but such systems are limited in that access to the information by one department is often dependent upon entry of information by at least one other department within the system. These currently available systems lack the flexibility to centralize workflow in a single physical location or decentralize workflow across multiple locations. Typically systems require that users make express requests for information rather than making workflow dynamically and simultaneously available to a plurality of authorized users.

These shortcomings are particularly problematic in the home healthcare industry, where reliance on such static systems can impede the efficiency of care delivery to home healthcare to patients. Additionally, home healthcare traditionally relies on information managed and documented by multiple branch offices. Such a system is inefficient and prone to error because care cannot be monitored from a single location but requires management and reliance at multiple levels within the system.

Thus, there is a need within business management systems for a dynamic system that provides a single conduit for patients, clinicians, office staff, family and friends, and referring facilities to access information from virtually any location, quickly and securely. Such a system would facilitate the flow of information and consequently the efficiency of providing the service to the patient.

### SUMMARY

A computer-implemented method for managing and delivering workflow to a home healthcare service is disclosed. The method comprises the steps of:
a. receiving a request from an application configured to communicate with an integration platform, said integration platform comprising a request interpretation component configured to use logic rules to convert said request to a standard format, at least one module configured to process said standard format request to generate a response, and to further process a workflow resulting from said response or said standard format request, and a response formatting component configured to use logic rules to convert said response to a format that a requesting application is configured to understand;
b. converting said request to said standard format using said request interpretation component;
c. processing said converted request using at least one of said logic rules to generate said response to said request, wherein said processing generates said workflow;
d. converting said response to said format that said requesting application is configured to understand using said response formatting component; and
e. processing said workflow using at least one workflow rule to generate at least one workflow result, and to make said workflow and said workflow result available to at least one authorized user.

An integrated business management system for managing workflow for a home healthcare service in response to requests executed by a user or automated by workflow rules is also disclosed. The system comprises:
a. a processing interface configured to communicate with and receive a request from an application, said interface comprising:
   i. a request interpretation component configured to convert said request to a standard format; and
   ii. a response formatting component configured to convert a response to a format that a requesting application is configured to understand;
b. at least one module configured to process said request to generate a response, and to further process a workflow resulting from said response or said request to generate a workflow result; and
c. a storage platform comprising at least one storage device configured to store said request, said workflow, and said workflow result that communicates with said at least one module.

An apparatus for managing and delivering workflow to a home healthcare service is also disclosed. The apparatus comprises:
a. means for receiving a request from an application configured to communicate with an integration platform, said integration platform comprising a request interpretation component configured to convert said request to a standard format, at least one module configured to process said request to generate a response, and to further process a workflow resulting from said response or said request, and a response formatting component configured to convert said response to a format that a requesting application is configured to understand;
b. means for converting said request to said standard format using said request interpretation component;
c. means for processing said converted request to generate said response, wherein said processing generates said workflow;
d. means for converting said response to said format that said requesting application is configured to understand using said response formatting component; and
e. means for processing said workflow using at least one workflow rule to generate at least one workflow result, and to make said workflow and said workflow result available to at least one authorized user.

A computer readable medium having stored therein instructions is also disclosed. When the instructions are executed by a processor, the instructions cause the processor to:
a. receive a request from an application configured to communicate with an integration platform, said integration platform comprising a request interpretation component configured to convert said request to a standard format at least one module configured to process said request to generate a response, and to further process a workflow resulting from said response or said request, and, a response formatting component configured to convert said response to a format that a requesting application is configured to understand, and a response formatting component configured to convert said response to a format that a requesting application is configured to understand;
b. convert said request to said standard format using said request interpretation component;
c. process said converted request to generate said response to said request, wherein said processing generates said workflow;
d. convert said response to said format that said requesting application is configured to understand using said response formatting component;
e. process said workflow using at least one workflow rule to generate at least one workflow result, and to make said workflow and said workflow result available to at least one authorized user.

Those and other details, objects, and advantages of the present invention will become better understood or apparent from the following description and drawings showing embodiments and examples thereof.

### BRIEF DESCRIPTION OF THE DRAWINGS

FIG. 1 is a schematic of an embodiment of the integrated business management system.

FIG. 2 is a flowchart diagram that shows the process of data and workflow management.

FIG. 3 is a schematic that shows the flow of data through the integrated business management system.

FIG. 4 is a schematic that shows the flow of workflow through the integrated business management system.

FIG. 5 is a schematic that shows the security component of the integrated business management system.

### DETAILED DESCRIPTION

### System Overview

Various embodiments of the disclosure provide an integrated business management system 100 that processes and manages data and workflow of at least one healthcare provider that provides home healthcare services, including rehabilitative services, nursing, palliative care, hospice care, geriatric care, and private duty services. The system 100 manages the flow of data and automates the workflow between clinicians, office staff, patients, and other authorized users of a single healthcare provider to provide home healthcare services to the patient. As used herein, the term workflow is defined to include at least one alert that is automatically generated in response to a request.

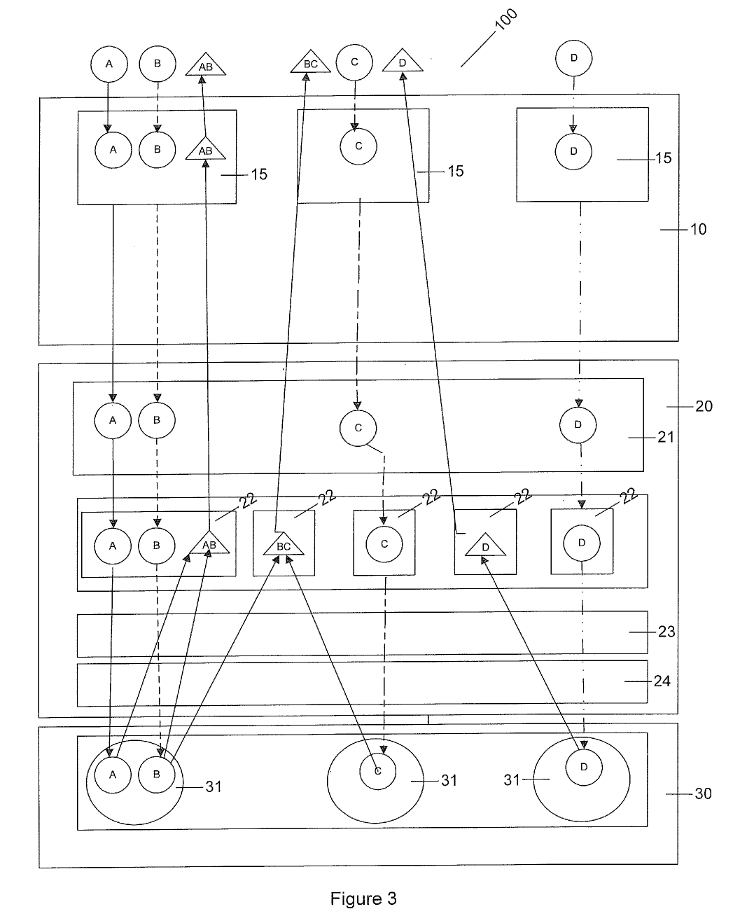

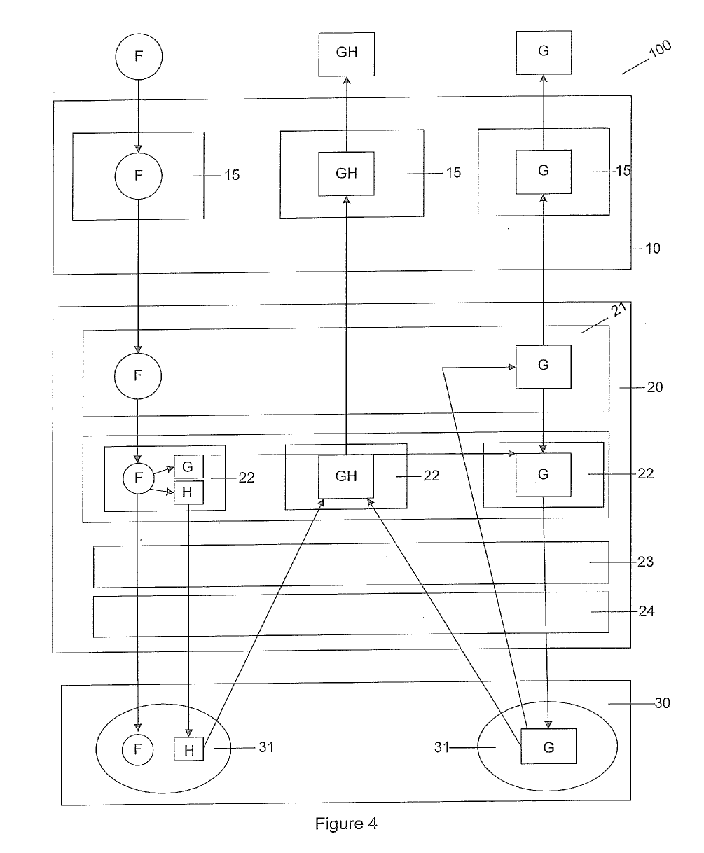

The system 100 also performs a plurality of tasks according to specific user requests. As used herein, request refers to a request for an action from the integration platform 20, wherein the action includes, but is not limited to, processing, storing, or retrieving data. The request is either a request to store data (shown as circles in FIGS. 3, 4), a request to retrieve data (shown as triangle in FIG. 3), or a combination thereof. In an example, requests are submitted through a standard HTTP request. In other examples, requests are submitted through a custom XML messaging system, a text message, a windows service, or other similar electronic request for information submitted via the applications platform 10.

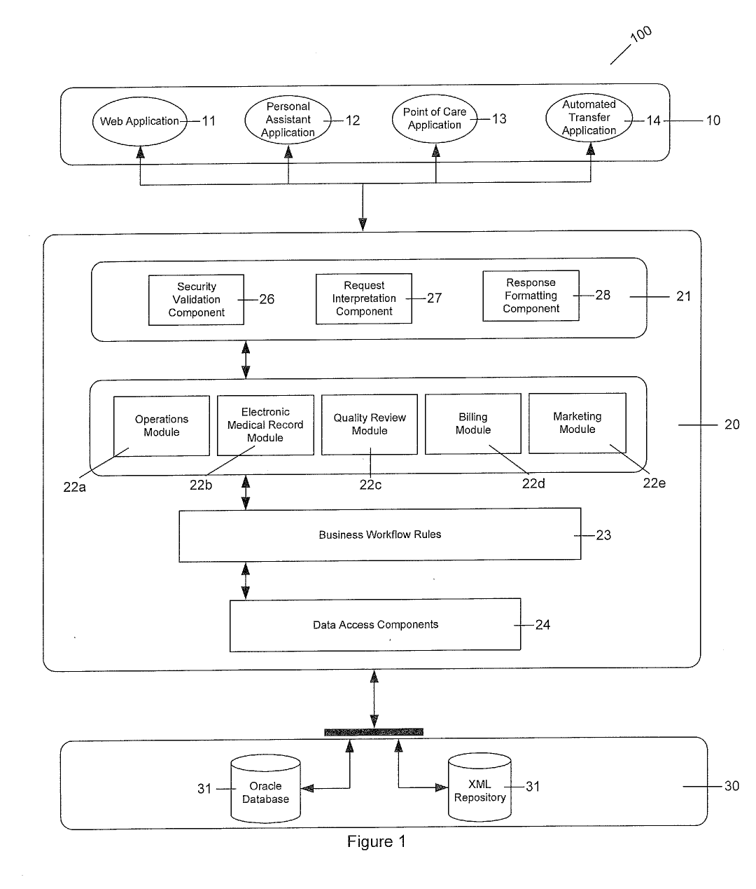

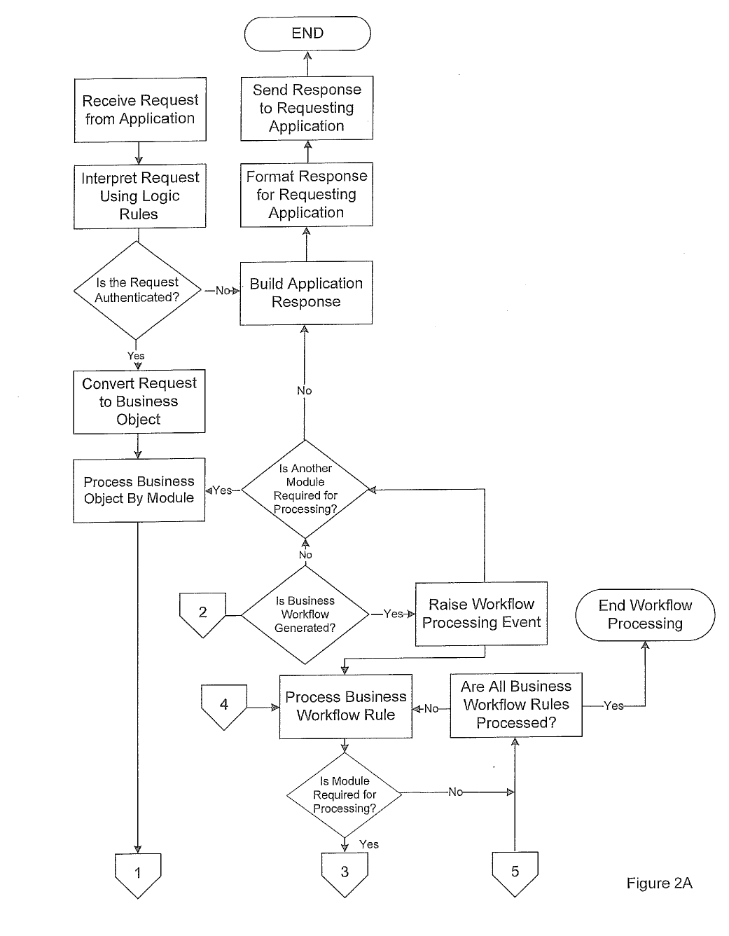

The system 100 is embodied in a computer system that comprises at least one processor that uses instructions to implement logic rules that interpret and process the request and generate a response to the request. See FIG. 1. The processor also uses instructions to evaluate and execute at least one business workflow rule 23 that processes workflow through the platforms 10, 20, 30 comprising the system 100. See FIG. 1. The pieces contained in the computer system 100 are those found in general purpose computer systems. Various embodiments of the disclosure may be implemented on computer-readable media. The terms “computer-readable medium” and “computer-readable media” in the plural as used herein may include, for example, magnetic and optical memory devices such as diskettes, compact disks of both read-only and writeable varieties, optical disk drives, hard disk drives, etc. A computer-readable medium may also include memory storage that can be physical, virtual, permanent, temporary, semi-permanent, and/or semi-temporary. A computer-readable medium may further include one or more data signals transmitted on one or more carrier waves.

The system 100 is comprised of a security component 26 (described below) that authenticates a request by confirming that the user is authorized to make the request. Authorized users include, for examples, clinicians, management staff, billing personnel, marketing personnel, quality assurance personnel, family and friends of the patient, and the patient within a single healthcare provider. As described in greater detail below and as shown in FIG. 1, the system 100 comprises a storage platform 30 that stores data and electronic documents in at least one database 31, and an integration platform 20 that has a plurality of modules 22 configured to use logic rules to process requests and generate responses, and to use business workflow rules 23 to manage workflow. Each module 22 is responsible for interpreting and managing specific types of related requests and workflow. Each module 22 acts as a conduit through which data pass. The integration platform 20 is configured to receive a request by a user from at least one of the applications 11, 12, 13, 14, 15 of the applications platform 10. The responses and workflow are then available for use by authorized users to facilitate delivery of the patient's home healthcare service. See FIGS. 3, 4.

### Process of Data and Workflow Management

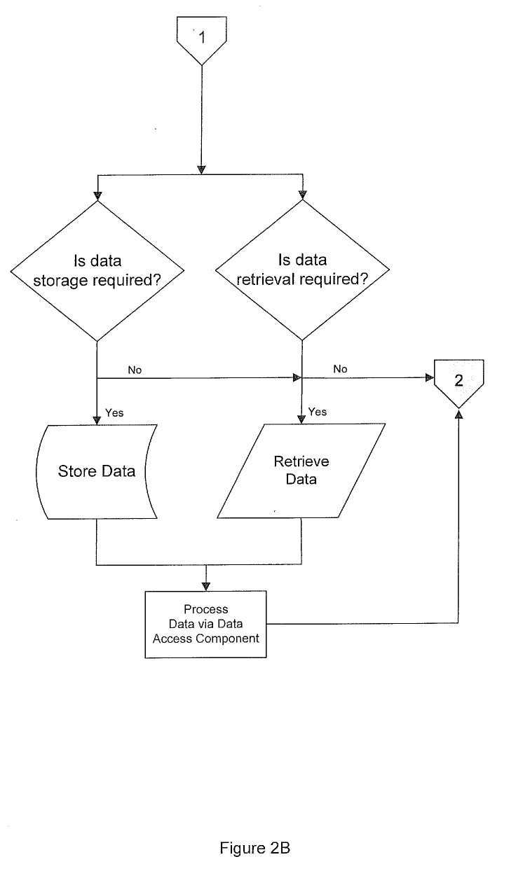

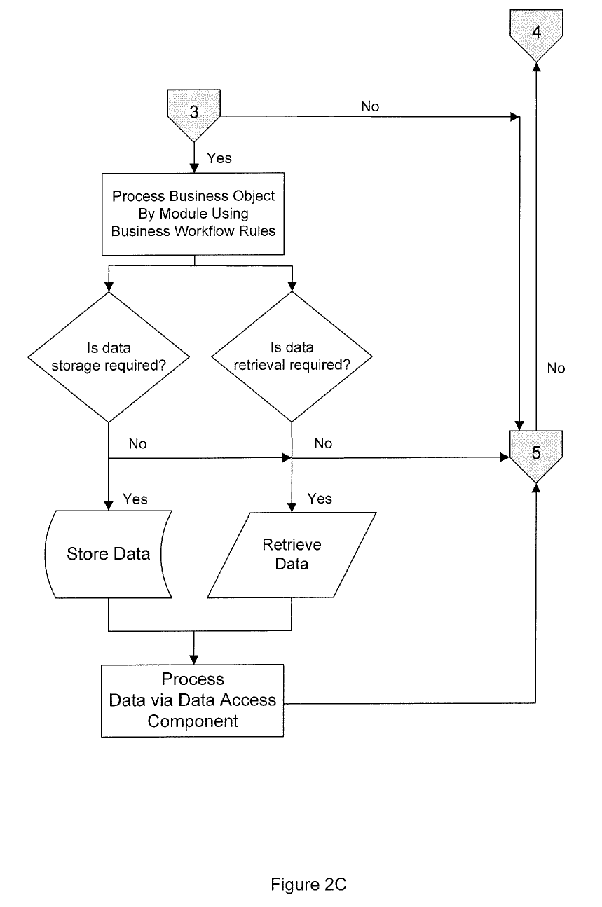

FIG. 2 is a flowchart that shows the process of data and workflow management. Each request is processed by the system 100 using at least one of a plurality of logic rules. Logic rules primarily manage the flow of data through the system. Logic rules, for example, contain knowledge of how to store, retrieve, and validate data for requests, or how to retrieve and manage multiple data sets to build integrated information results.

The system 100 comprises a plurality of business workflow rules 23 that enact workflow processes through at least one module 22 to impart integrity and efficiency to the system. As shown in FIG. 2, through a sequence of operations, workflow results move in a consistent and timely manner through the system 100 to minimize the number of errors made in the delivery of homecare and any consequent negative impact on patient care and business operations. Business workflow rules 23 make workflow dynamically available to authorized users without requiring user intervention to initiate the transfer of workflow. Business workflow rules 23 vary depending on the type of home healthcare agency and are executed to enforce established business processes and best practices.

For example, during a patient intake, the integration platform receives a request to intake the patient. When the request is processed, the system 100 automatically processes a number of workflow rules 23 in response to the workflow generated by the request for patient admission. For example, one of these rules executes to evaluate if the number of admissions for a skilled discipline exceeds capacity of staff to fulfill the need within an established time frame. If this condition is met, other events may be triggered such as sending automatic alerts to managers to ensure the patient is covered. Workflow rules 23 may also generate tasks to a targeted group to perform. In another example, when the initial patient evaluation is completed and submitted to the integration platform 20, a series of reviews will be generated based upon the results of the evaluation. Different review tasks are generated based upon the diagnosis of the patient, or the medications the patient is taking, for example. In an example, the automatic transfer of workflow becomes active when a user is connected to the Internet, such as by a computer or handheld device. In another example, the applications platform 10 comprises an automated transfer application (not shown) that facilitates the automatic transfer of the workflow by connecting to the internet and transmitting data to the interface.

As shown in FIG. 2, the integration platform 20 is configured to receive a request from at least one of the applications 11, 12, 13, 14, 15 of the applications platform 10. A user initiates the request by inputting the request into one of the applications 11, 12, 13, 14, 15. The processor uses at least one logic rule to receive and interpret the request to determine who is malting the request and/or what the request is, for example, thereby enabling authentication to execute. The logic rules send the request to the security component 26 for authentication to confirm that the user who input the request is authorized to make the request. See FIG. 2. If the request is not authenticated, then logic rules build a response that explains why the request is not authenticated, such as for example because the user does not have permission to access the resource requested. See FIG. 2. The response is sent to the response formatting component 28 to convert the response to a format that the requesting application 11, 12, 13, 14, 15 is configured to understand. The formatted response is then sent to the requesting application 11, 12, 13, 14, 15. See FIG. 2.

If the request is authenticated, then the logic rules instruct the processor to send the request to the request interpretation component 27 where the request is converted to a business object, as shown in FIG. 2. The business object is a format that each module 22 of the integration platform 20 is configured to understand. The business object contains information necessary to fulfill the request, such as for example, requester identification, the type of application making the request, what resource is being requested, and any additional parameters that may be required to fulfill the request, such as data that need to be stored in the storage platform 30.

Next, the business object is sent to at least one of the modules 22 for processing. See FIG. 2. Logic rules interpret the business object and instruct to which module or plurality of modules each business object should be sent. In an example, the business object is processed by one module 22. In another example, the business object is processed by more than one module 22 sequentially, wherein the business object is processed by a first module before being processed by a second module and so forth. In an example, the first module that processes the request controls the execution of subsequent modules and waits for a result from each module before evaluating what action needs to take place next to fulfill the request. In another example, the business object is processed by more than one module 22 in parallel, wherein the business object is processed by more than one module at the same time. FIG. 3 depicts an example of movement of requests and responses through the system. Optionally, the processing of the business object by the module 22 comprises storing data in at least one of the storage databases 31 stored in the storage platform 30 (shown as circles in FIG. 3) or retrieving data from at least one of the storage databases (shown as squares in FIG. 3). As shown in FIG. 3, data pieces A, B, C, D are stored in separate databases 31. In an example where the processing comprises at least one of storing or retrieving, the stored and/or retrieved data is processed using a logic rule.

In an example, the processing of the business object or the processing of stored and/or retrieved data does not generate workflow. See FIG. 2. Logic rules send the processed data to the response formatting component 28, which formats the response to the request in a format that the requesting application is configured to understand. The response formatting component 28 sends the response to the requesting application 11, 12, 13, 14, 15.

In another example, the processing of the business object or the processing of the stored and/or retrieved data generate workflow that must be stored or further processed to generate a workflow result. See FIG. 2. In an example, the workflow result is stored or further processed to generate additional workflow results. In an example, the module 22 fulfilling the request identifies a workflow rule 23 that must be processed. The workflow triggers a workflow processing event that activates at least one of the workflow rules 23. The workflow event raised contains the business object as an argument so the workflow rule 23 responding to the event has the data needed to process the rule. The workflow rule responding to the event interprets the business object to determine what processes need to be executed in response to the workflow event being raised.

As shown in FIG. 2., after the event is raised, the event is processed using at least one business workflow rule 23. In an example, the workflow is processed independent of any of the modules 22. In another example, the workflow is processed by at least one of the modules 22 using at least one of the business workflow rules 23. Optionally, the processing of the workflow by the module 22 using the workflow rules 23 comprises storing the workflow result in at least one of the storage databases 31 of the storage platform 30, or retrieving the workflow result from at least one of the storage databases 31. In an example where the processing comprises at least one of storing or retrieving, the stored and/or retrieved workflow is processed using a business workflow rule 23.

In an example, the workflow is processed by more than one module 22 sequentially, wherein the workflow is processed by a first module before being processed by a second module and so forth. In another example, the workflow is processed by more than one module 22 in parallel, wherein the workflow is processed by more than one module at the same time. See FIG. 2.

Workflow processing terminates after all applicable workflow rules 23 have been processed. See FIG. 2.

FIG. 3 is a schematic that shows the flow of data through the integrated business management system 100. As shown, requests in the form of data pieces A, B, C, D are input (shown as circles) into one of the applications 11, 12, 13, 14, 15. The request is processed by the information processing interface 21 for conversion of each request to a business object. Each business object is passed through one of the modules 22 for processing and is sent to one of the storage databases 31 for storage. Each request generates a response. Responses (shown as triangles) retrieve data A, B, C, D from storage devices, process the data in one of the modules 22, such as by integrating more than one piece of data (AB, BC), and send the response A′B′, B′C′, D′ to the response formatting component 28 prior to sending the response to the requesting application 11, 12, 13, 14, 15.

FIG. 4 is a schematic that shows the flow of workflow through the integrated business management system 100. As shown, a request in the form of data piece F is input (shown as circle) into one of the applications 11, 12, 13, 14, 15. The request is processed by the information processing interface 21 for conversion of the request to a business object. The corresponding business object is passed through one of the modules 22 for processing and is sent to one of the storage databases 31 for storage. The request generates workflow G and H that raises a workflow processing event. Workflow (shown as squares) H is processed by the module 22 and is sent directly to one of the storage databases 31. Workflow G is processed by the module 22 and is then sent to a second module 22 sequentially for subsequent processing before being sent to one of the storage databases 31. Workflow processing results in a workflow result G′H and G′ that is available to authorized users.

### Applications Platform

The applications platform 10 is comprised of at least one software application 11, 12, 13, 14, 15 that is configured to submit a request A, B, C, D, F to the integration platform 20 for processing and interpretation using logic rules. Each software application 11, 12, 13, 14, 15 is also configured to receive a response to the request from the integration platform 20. In an example, the response is a single piece of data or processed and integrated data AB, BC, D′ generated by at least one of the modules 22 (described below). See FIG. 3. In an example, the applications platform 10 has multiple software applications 11, 12, 13, 14, 15 that operate independently. As shown in FIG. 2, a request is inputted by an authorized user into at least one application 11, 12, 13, 14, 15 of the applications platform 10. Examples of requests include, but are not limited to, patient or clinician demographic data, treatment data, medical record data, physician orders, employee data, and the like, and may optionally include copies of documents, photographs, audio, and video.

The applications 11, 12, 13, 14, 15 are also configured to receive a response from the response formatting component 28 of the integration platform 20. The response is accessible by an authorized user and comprises integrated data retrieved from the storage platform 30 that associates at least one piece of data using logic rules as described above. Examples of responses include, but are not limited to, a patient's medical record, progress reports, scheduled services, billing history and laboratory results. Responses provide information to facilitate the coordination of patient care, information to efficiently administer the complex rules of the perspective payment system (PPS) and managed care payment systems, and information to ensure best practices are followed when delivering care to the patient.

Applications 11, 12, 13, 14, 15 are housed, for example, on a user's computer, a hand-held device, or a server. Each application 11, 12, 13, 14, 15 submits a request in a format that the application is configured to understand. As described in detail above, an authenticated request is automatically transferred to the request interpretation component 27 of the integration platform 20. The automatic transfer of the request by the application operates in real-time and the integration platform 20 is configured to process the request using at least one of the logic rules and optionally associates or integrates a plurality of stored data to generate a response comprising integrated data that is dynamically available to authorized users.

In an example, each application 11, 12, 13, 14, 15 comprising the applications platform 10 has a set of customizable logic rules that confirm that fields of data required for executing the selected function are populated and that the types of data are valid prior to submitting the raw data to the integration platform for processing and/or storage and integration.

As shown in FIG. 1, examples of applications include, but are not limited to, a web application 11, a personal assistant application 12, a point of care application 13, an automated transfer application 14, and a third party portal (not shown).

### Web Application

Authorized users having one of a variety of roles within a home healthcare provider organization, or having a relationship with a patient who is receiving service from a home healthcare provider, such as an overseeing physician or family member, are authorized to use the web application. The security validation component 26 controls access to the system 100. The web application 11 offers filtered views, as controlled by the security component 26 (described below), of web forms and is configured to enable a user to view responses generated by the integration platform 20. The web application 11 is configured to provide customized views of responses depending on the type of home healthcare provided by the agency (e.g., rehab versus hospice) and the location of that agency. The design of the web application 11 provides a flexibility to the system 100 that allows centralized or decentralized business operations. Healthcare providers contained in multiple regions can have business operations centralized in a single headquarters, or they can operate independently at each region, either as a whole, or only as a subset of operations. The system 100 provides this flexibility through its security validation component 26 and by the design of the integration platform 20.

The web application 11 is used to submit requests including patient data, such as patient admission data demographics, and past medical history, and to automatically initiate workflow such as tasks that clinicians and other staff members must perform as the patient moves through the care delivery process. Examples of tasks include, but are not limited to, verifying insurance, clinician approval of verbal intake orders, and obtaining authorization for patient services. In another example, a patient information request is received by the integration platform. The integration platform 20 responds by retrieving data from at least one of a plurality of databases 31 and converting the multiple data sets into an integrated information response.

### Personal Assistant Application

The personal assistant application 12 manages the daily schedule of users, such as clinicians and office staff, and is configured for an authorized user to input data request, including for example, the clinician's schedule, including appointments with patients, meetings, paid time off or vacation time, personal or “free” time, expenses, and mileage. The personal assistant application 12 is configured to enable users to independently schedule meetings or assignments received and to transfer patient-related and service-related data, in the form of a request, to the integration platform 20 for processing and optionally storage in the storage platform 30 to make those data immediately available, either in the form of stored data or as workflow, to authorized users of the system. In additional examples, the personal assistant application 12 tracks a clinician's or staff member's mileage from one location to another, such as from the user's residence or office to the patient's location where the home healthcare is provided. Optionally, the personal assistant application 12 is integrated with a map interface such as Map Quest®.

In another example, the personal assistant application 12 is also configured to manage a user's expenses and reimbursement requests, such as by recording expenses incurred by the user in providing the service to a patient. In an example, processing of the expenses and reimbursement requests generates business workflow. In that example, workflow rules 23 process the expenses and reimbursement requests to integrate expense-related data with clinician payroll data to generate integrated information that is outputted to the billing and/or human resources staff for reimbursement or approval. This workflow is processed automatically without a request being received from an application 11, 12, 13, 14, 15.

In another example, the personal assistant application 12 is configured to alert a user to updates or messages, such as to remind a clinician or staff member of an upcoming assignment deadline or that he/she has not completed an assigned task, to schedule follow-up appointments with the patient, to send a message to an authorized user, to notify a clinician or staff member that a submitted expense has been approved or denied, and the like. In an example, when a clinician schedules an appointment with a patient in the personal assistant application 12 and documentation that the appointment occurred is not entered into the point of care application 13 (described below) within an established time frame, one of the applications 11, 12, 13, 14, 15 automatically reminds the service provider to complete the required documentation. The reminder is generated by a request from a service application 11, 12, 13, 14, 15 which executes on scheduled intervals. The integration platform responds to the request by processing data inputted from the personal assistant module 12 and the point of care application 13.

### Point of Care Application

The point of care application 13 is configured to document that the home healthcare service was delivered to the patient, including inputting service-related data to the point of care application 13 that are received by the integration platform 20 as a request that processes and/or stores the data. In examples, the point of care application 13 includes fillable forms into which the user enters data to document that the appointment with the patient took place and to provide specific clinical data related to the appointment. In examples, the forms summarize the appointment, such as the reason for the requested service, the service provided to the patient, the date, time, and location of the appointment, whether resolution was achieved, if follow-up appointments are necessary, and the like. After a patient is assigned to a particular clinician, the clinician can continue to document information related to the client throughout the service period.

Optionally, the point of care application 13 links to or provides access to reference tools to help the clinician, staff members, and the like to complete assignments and perform service-related tasks, to validate information or data related to the patient, and to confirm compliance with regulations or industry standards.

### Automated Transfer Module

In an example, the applications platform 10 also has an automated transfer application 14 that facilitates the automatic transfer of data from at least one of the applications 11, 12, 13, 14, 15 of the applications platform 10 to the integration platform 20 through the request component 27 and the output of integrated information from the integration platform 20 to one of the applications 11, 12, 13, 14, 15. through the response formatting component 28. The automatic transfer application 14 connects to the internet and transmits the result of a workflow process executing.

### Third Party Portal

In an example, the applications platform further comprises a third party portal (not shown) that is configured to enable the patient or third parties to submit a request or access or receive integrated information from the system 100 so that the third party is able to monitor the progress of providing home healthcare service to the patient. Third parties are defined herein as anyone who has been authorized by the patient or on behalf of the patient, including family members and physicians. In an example, the security component 26 is configured to identify the third party as non-employees of the homecare provider and limits access to and views of patient information based upon the type of third party accessing the system. For example, physicians are able to request a status report and other patient-related information for the patients they are treating to monitor the progress of the patient. In another example, family members who are authorized users are able to request patient information. In another example, homecare employees are able to request more detailed patient information. The information that each party accesses is compiled from data captured from staff members managing the case and data submitted by clinicians in the field during the ongoing treatment of the patient.

### Integration Platform

The integration platform 20 is comprised of an information processing interface 21 having a security component 26, a request interpretation component 27, and a response formatting component 28. The integration platform 20 is also comprised of at least one module 22, a library that stores a plurality of business workflow rules 23, and at least one data access component 24. All requests and responses pass through the information processing interface 21. The integration platform 20 is configured to receive and interpret a request from at least one of a plurality of application types 11, 12, 13, 14, 15, such as the web, personal assistant, or point of care applications described above. The integration platform 20 is also configured to use at least one business workflow rule 23 to process workflow generated by a request that is received from an application 11, 12, 13, 14, 15. The security component 26 authenticates a request received from an application 11, 12, 13, 14, 15. The integration platform 20 is configured to receive requests in a plurality of formats and uses logic rules to direct the request to the request interpretation component 27, which interprets and standardizes the request into a standard format that all of the modules are configured to understand and process. This creates a many to many relationship between the applications 11, 12, 13, 14, 15 and the data stores with a single point of entry for a request and a single point of exit for the response to the request. As such, any application is configured to request data from any data store without having to know anything about the data store. All processing required to respond to the request is abstracted by the framework. In examples, a request is received from an application using the HTTP protocol, a text messaging system using the SMS protocol, a Windows application using a known Windows protocol, or a mobile application making an XML SOAP protocol request. Following authentication, the request is directed to the request interpretation component for conversion to a business object. Each business object is processed by logic rules in a substantially identical manner to build a response.

### Information Processing Interface

The information processing interface 21 comprises the security component 26, the request interpretation component 27, and the response formatting component 28. The security component 26 is configured to receive a request in any format from applications 11, 12, 13, 14, 15 of the applications platform 10 to authenticate the request. Authenticated requests are sent to the request interpretation component 27 for conversion to a business object, which is a format that the modules 22 are configured to understand. Requests are converted to a business object independent of the type of request and the application from which the request was received. In examples, request formats include, but are not limited to, XML, flat file text, and SQL server data stores. Following conversion, each business object is sent to at least one of the modules 22.

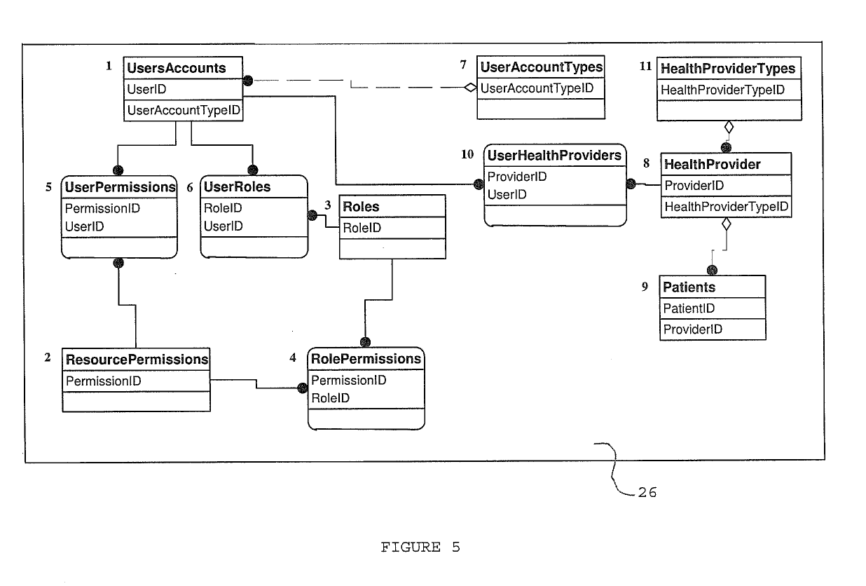

The information processing interface 21 also comprises a security authentication component 26 such as the one shown in FIG. 5 that is configured to support more than one health provider. Each user account is associated with an account type 7. Account types 7 include, for example, employee, physician, client, family member, or the like. Access to data stored in or responses generated by the system 100 is granted based upon the type of user account making the request and the permissions associated with the user account 1. Account type 7 represents the type of user making the request, such as for example, an employee of the healthcare provider, a physician or a patient. The security authentication component 26 is configured to enable the account type 7 to grant the user permission to make a specific request, receive a specific response, or to perform a specific function. In an example, an employee of a healthcare provider who uses the applications platform 10 to request to view a patient's chart is granted permission by the security authentication component 26 to view a comprehensive set of patient information including patient encounter documentation, medication information, and internal communications. In another example, a patient family member who uses an application 15 of the applications platform 10 to request to view a patient's chart is granted permission by the security authentication component 26 to view only the patient encounter documentation. In yet another example, a physician who uses the applications platform 10 to request to view a patient's chart is granted permission by the security component 26 to view a less detailed and more focused summary of the patient's electronic medical record including, for example, past medical history and scheduled encounters.

As described above, the system 100 comprises at least one healthcare provider 8. Each patient 9, including information associated with that patient, and each user account 10 is associated with at least one specific healthcare provider 8. The security component 26 limits access to patient information by granting permission to information only when both the user and information being requested are associated with the same healthcare provider 8. As such, the system 100 is able to support more than one healthcare provider while also limiting access to information. A user who is granted access to the information associated with more than one healthcare provider is able to access all information seamlessly within the system 100.

Supplementing the security component 26 in addition to roles, permissions and account types, is an additional layer which controls access to individual records of data. One or more healthcare providers 8 are configured within the security component 26. Most data within the databases 31 are owned by a healthcare provider. Patients 9 and user accounts 10, for example, are associated with one or more healthcare providers. A request for information is fulfilled only when both the user and the object being requested have associations with the same healthcare provider. Because of this, the security component 26 can support many different healthcare providers with a single instance of the system while still having the necessary separation of data amongst each healthcare provider. This enables an end user who is granted access to more than one healthcare providers records to be able to access all records seamlessly within a single instance.

The system 100 is also able to support more than one type of healthcare provider, such as for example providers who provide homecare providers who provide hospice care. Each agency has a customized view of information. In an example, billing periods and documentation requirements vary between homecare and hospice regulations. The system 100 is designed to support this seamlessly based upon the configuration of the healthcare provider and the patients.

### Business Workflow Rules

Business workflow rules 23 are comprised of defined business rules that instruct that the workflow generated by a request from an application to be automatically processed to make the workflow available to all authorized users of the system who have a need to now that the workflow exists. The business workflow rules 23 implement and enforce a matured business process that reduces the number of errors made and that identifies any errors that are made to minimize the impact on patient care and business operations. Execution of workflow rules 23 may require the modules 22 to process multiple workflow rules 23 and consequent integration of the data as shown in FIG. 4. Functionalities that the workflow rules 23 control or instruct include, for examples, generating alerts to users of the system 100 that particular actions have taken place, generating and delegating tasks for users of the system 100 to perform, and data quality checks against established business processes.

As described in detail above, a schematic showing an example of the generation and processing of workflow is shown in FIG. 4.

### Data Access Components

The data access component 24 of the integration platform 20 is configured to facilitate the transfer of data to and from the databases 31 of the storage platform 30. In an example, processing of the business object by one of the modules 22 requires that data be retrieved from one of the storage databases 31. The data access 27 component pulls data from the relevant database 31 and directs it to the module 22 for processing the request. In an example where data to be retrieved exists in more than one database 31, the data access component 27 is configured to interface with the different databases 31 to process the data to generate the response to the request and/or to process the workflow.

### Modules

In an embodiment, the integration platform 20 is comprised of at least one module 22 that is configured to utilize the business object to generate a response using logic rules. The modules 22 are configured to receive a business object from the request interpretation component 27 of the information processing interface 21. The modules 22 are also configured to process workflow that is generated by a request. The modules 22 use business workflow rules to process workflow when a workflow processing event is raised. In examples, the at least one module 22 is configured to automatically facilitate, for example, communications between users, such as messages conveying patient needs to a clinician, or to direct information to the appropriate application. In an embodiment, the integration platform 20 comprises one module 22. In another embodiment, the integration platform 20 comprises more than one module 22, 22. Examples of modules 22 include the operations module, quality module, and marketing module as described below.

Operations Module

The operations module 22a is configured to process business objects related to patient intake. Specifically, data in the form of a request to input data related to patient intake are converted to a business object by the information processing interface 21 (described above) and the operations module 22a then processes that business object and optionally stores the data and/or retrieves data from the storage platform 30 via the data access component 24 to integrate with the business object to generate a response. Optionally, the processing of the business object generates a business workflow that raises a workflow event. Workflow is processed using business workflow rules 23 as described above. After the request is converted to a business object, an application response is built that is then formatted in the response formatting component 28 and is sent to the requesting application 15. In an example, the data that are received as a request from the application 15 include patient-specific information that is related to the service to be provided to the patient, such as for example, demographic information, insurance information, physician information, contact information for the patient's next of kin, medical diagnoses and orders, and reason for the home healthcare service. These data are converted to a business object, are processed by the operations module 22a using logic rules, and are stored in one of the storage databases 31. The request to store this patient data generates a business workflow that raises a workflow processing event that is processed by the operations module 22a using business workflow rules 23 to assign an appropriate service provider to the patient. In another example, the event is processed by the quality module 22c to generate a plan of care for the patient.

In an example, the business object that is processed by the operations module 22 is derived from data related to at least one clinician, including for example the clinician's residential or employment address, the skill level of the clinician, the clinician's areas of expertise or specialty, demographic information about the clinician, the clinician's licensing and certifications, or the like. These data sets are converted to business objects as described above and business workflow rules 23 are used to assign the patient to a clinician, based for example on a clinician's daily schedule, including for example appointments already scheduled, pre-scheduled paid time off and vacation time, and current workload of the clinician. In an example, the operations module 22a is configured to automatically assign an appropriate clinician to the patient using workflow generated by the business objects described above, including such data as geographical location of the clinician and the patient's point of delivery, skill level and experience of the clinician and the service requested or required by the patient, and a clinician's availability to provide the home healthcare service to the patient as determined by reviewing the clinician's schedule. Optionally, the operations module 22a further comprises a referral assistance tab (not shown) that allows a staff member to assign the most appropriate clinician to cover the referral. Workflow rules 23 process the workflow generated by the business object and automatically suggest the most appropriate clinician to whom to assign the case. The operations module 22 optionally comprises an on-call feature that enables the operations team to enter and manage on-call scheduling coverage using the scheduling module. Access to information resulting from the processing of workflow is immediate to authorized users.

In an example where there is a patient intake after-hours and that patient requires immediate assistance, the operations module 22a automatically responds to the workflow generated by the intake to assign the clinician by using the on-call tab (not shown) of the operations module 22a. The on-call tab reviews the patient data, described above, to identify the patient's needs and the on-call clinician's data in order to automatically assign an appropriate clinician to the patient.

In an embodiment, the operations module 22a is also configured to engage or enable payroll and billing capabilities. The operations module 22a tracks and records clinician time and assignments and uses the workflow generated by the processing of those data to calculate and record the earnings of each clinician. The payroll team is able to view and/or access expenses and mileage submitted using the personal assistant application 12 described above. In an example, the data from the personal assistant application 12 are processed and resulting workflow is made immediately available in real-time such that an authorized payroll team member can access the submitted expense documentation (generated by manipulating data to generate information) and approve the expenses at any time without having to initiate a request for the data necessary to make the approval. If an expense is not approved, then an alert is sent to the clinician via the personal assistant application 12. In an example, a submitted expense is approved when a member of the payroll team selects a document listed in the submitted expense screen and approves the expense to be processed when payroll is completed, which may be immediately. Preferably, the mileage approval tab is integrated with a map interface such as Map Quests so that mileage from the clinician's point of origin to the patient's point of delivery location is calculated for reimbursement to the clinician. As described above, the mileage data are requested from the personal assistant application 12 and approval can occur at any time after entry into the personal assistant application 12.

The operations module 22a is configured to enable the payroll team to view data submitted via the personal assistant application 12 (including expenses and mileage data) and point of care application 13. These data are converted to a business object by the request interpretation component 27. The operations module 22a utilizes business workflow rules 23 to process the workflow processing event generated by the processing of the business object. The workflow is made available to the payroll team to approve the expenses and payroll for a given clinician at any time.

Optionally, the operations module 22a comprises a human resources tab (not shown) that enables the human resources team to access and track the clinician-related data (described above), including pertinent human resources information, such as demographic data, employment data, certifications, and licenses. These data are entered manually using one of the applications 11, 12, 13, 14, 15 of the applications platform 10 and then are received by the information processing interface 21 from the applications platform 10. Data for new team members or clinicians can be added to the system 100 to be accessed and tracked at any time. Once submitted, the operations module 22a is configured to convert the data to a business object that is available and readable for use within the system as described above. Optionally, the operations module 22a enables the human resources team to access and track vacation information and is linked to receive information directly from the personal assistant application 12. The operations module 22a has a vacation or personal time off tab (not shown) that enables the human resources team to approve or deny requests received via the personal assistant application 12 at any time.

Optionally, the operations module 22a comprises a physician orders processing tab (not shown) that allows authorized users to immediately access and process orders that are received from the point of care application.

Electronic Medical Record Module

The electronic medical record module 22b compiles data associated with providing a service to the patient to create an electronic medical record. In examples, the electronic medical record module 22b processes patient-related data, including appointment schedules, laboratory results, documentation of patient encounters, and any other documentation related to providing the service to the patient. In an example, one of the applications 11, 12, 13, 14, 15 in the applications platform 10, such as the point of care application 13 described above, is configured to submit data to the patient's medical record, including submitting scans of paper documents, status of providing the service to the patient, tracking progress of the patient, and actions to be taken to continue or finalize patient care. These data are processed by at least one module 22 and then the resulting workflow is processed using business workflow rules 23. In examples, the electronic record comprises patient-specific service related documents such as those available to the clinician using the point of care application, service orders, patient's schedule, such as when appointments are scheduled for the patient or when an appointment was completed, status of providing the service to the patient, such as tracking the progress of the patient through the home healthcare system and which clinician or staff member completed each step in the system, and actions to be taken to continue or finalize servicing the patient.

Optionally, the electronic medical record module 22b comprises at least one of a physician orders tab that identifies physician orders, a patient schedule tab that identifies visits or appointments that were completed or that are scheduled for a patient, or a status history tab that reports the patient's progress through the care delivery process.

Quality Module

In another example, the integration platform 20 has a quality module 22c configured to initiate a review process of the service provided to the patient. The quality module 22c comprises an initial review tab configured to provide access to patient-related data following completion of intake and submission of information through the point of care application 13 documenting that care has been provided to the patient. In an example, the quality module 22c is also configured to provide communication between the quality team and the clinician through an action tab or the like to provide feedback on the documents created as part of the point of care documentation and to request any changes, corrections, or updates that the quality team deems necessary. A document version control tab (not shown) ensures that all edits made to records are appropriately archived and tracked. Preferably, the quality module 22c is configured to enable the changes that are made to be catalogued and notations made regarding any changes or revisions. In another example, the quality module 22c is configured to enable quality review teams to see the upcoming scheduled reviews. Preferably, the quality module 22c is configured to schedule upcoming reviews, including time frames for completing the reviews.

In an example, the quality module 22c is further configured to determine the appropriate level of service to provide to the patient based on the amount of payment the home healthcare provider expects to receive for the home healthcare service.

In another example, the quality module 22c generates an output of a standard “plan of care” physician order for the patient built from data captured from the web application during patient intake, data captured from the point of care application 13, and data captured by an application utilizing the quality module 22c. This output is automatically generated by the system 100 upon an event identified by the business workflow rules 23, which includes, for examples, an admission assessment completion, quality review, and the patient having been properly coded (ICD-9 diagnosis codes).

Billing Module

In an example, there is a billing module 22d that is configured to initiate and finalize billing for a patient who receives home healthcare through the system. In examples, the billing module 22d is configured to verify insurance data and to authorize delivery of the service before it is provided and then to finalize the billing based on workflow generated by processing a request. The billing team is prompted after intake to review and validate billing data provided. Optionally, the billing team reviews insurance data to either approve or deny the charge of the service to the insurance. In an example, insurance data are reviewed and validated prior to submission via one of the applications 11, 12, 13, 14, 15 described above, and then the results of the review are submitted using one of the applications. As described above, the modules 22 of the system 100 are configured to use business workflow rules 23 to process workflow to generate integrated information that is dynamically accessible and viewable by authorized users, thereby making the billing information accessible in real-time to any authorized user.

In an example, the billing module 22d is also configured to enable the authorization of delivery of home healthcare to a patient, such as for example, when insurance will cover the service. Many insurance carriers require that a service be authorized prior to providing the service. The billing module 22d tracks authorization and notifies clinicians and other authorized users when authorization is required.

The initial billing tab (not shown) enables the billing team to identify clients who are ready to be billed and to track which bills have been processed. Preferably a client cannot be billed until the quality team has approved the client for billing. The final billing tab enables the billing team to track which clients need to be billed.

Marketing Module

In another example, the integration platform 20 comprises a marketing module 22e that is configured to monitor and evaluate who requests the home healthcare service, who refers the patient to the home healthcare provider, with what frequency, and the like. The marketing module 22e is also configured to process workflow using business workflow rules 23 to make integrated information dynamically available to authorized team members, as described above. In an example, the marketing module 22e comprises an account review tab that enables marketing team members to evaluate each patient account to determine who referred the patient to the home healthcare provider. In an example, there is an alert tab that alerts marketing team members to workflow such as messages, updates, and other reminders, as described above. This workflow is further processed by other modules 22 such as payroll for distribution of incentives to marketing team members when thresholds established in the business workflow rules of business generation are reached.

In another example the marketing module 22e processes data captured by the field marketing staff inputted by the personal assistant application 12 which includes data on prospects or clients visited, the time spent with the prospect or client, and the outcome of the visit and next action required. The marketing module 22e associates these data with other pieces of data in the system 100, such as but not limited to the amount of business generated by the marketing staff member, amount of business generated by the clients, and goals established for each marketing staff member and client. The marketing module 22e processes the previously referenced data and builds workflow to generate real time operational dashboards to track the performance of a marketing staff member, client, prospect, or home healthcare agency.

Delivery Module

Optionally, the system 100 further comprises a delivery module (not shown) which monitors ongoing patient care. In an example, after the service is coordinated, an established frequency of visits to be provided to the patient (e.g. nursing to visit 2 times per week) is requested by the physician. This data is captured at the point of care during the initial assessment of the patient, and stored for reference during the delivery of patient services. When service is scheduled via the personal assistant application 12, and is delivered and documented via the point of care application 13, workflow is generated that is processed using business workflow rules 23 to determine if visit frequency per service is being over- or under-utilized, in which case notification of non-compliant visit patterns are sent to clinicians.

In another example, data captured by the delivery module is associated with data captured by the billing module 22d for volume of services authorized for payment. If the volume of scheduled service exceeds payment authorization, the system alerts clinicians to resolve the issue prior to delivery of the non-reimbursable service.

Earnings Module

Optionally, the system 100 further comprises an earnings module (not shown) configured to enable each clinician or staff member to track their earnings based on integrated information generated by the within the operations 22a and delivery modules (not shown), such as hours worked, patient visits completed, mileage, and the like. The earnings module enables the authorized user to see the total areas tracked for compensation. In another example, the earnings module is configured to enable the home healthcare service provider to track earnings of the business management service, an individual clinician, team, or office staff.

### Storage Platform

The storage platform 30 comprises at least one storage device 31 configured to store data submitted from the requests, workflow, or workflow result. The storage platform 30 is configured to store data retrieved from the business objects submitted by the modules. In addition, the storage platform 30 enables access to the stored data for populating business objects for use in building responses. The storage platform 30 communicates with the data access component 24 of the integration platform 20 to facilitate a two-way communication. In an example, the storage database 31 is an oracle database. In another example, the storage database is an XML repository.

While the foregoing has been set forth in considerable detail, it is to be understood that the drawings and detailed embodiments are presented for elucidation and not limitation. Design and configuration variations may be made but are within the principles of the invention. Those skilled in the art will realize that such changes or modifications of the invention or combinations of elements, variations, equivalents, or improvements therein are still within the scope of the invention as defined in the appended claims.

### SPECIFIC EXAMPLES

The following examples are for illustrative purposes only and should not be interpreted as limitations of the claimed invention. There are a variety of alternative processes available to those of skill in the art which would similarly permit one to successfully generate and process workflow disclosed herein.

### Example 1

### Home Healthcare Service

In this example, the clinician is a physical therapist and home healthcare service (i.e., the physical therapy) is initiated by the patient's primary care physician. The physician submits a request using the application configured to submit a request for service to the integration platform. The request includes patient demographic data, data about the requesting physician, physician orders, insurance information, and medical history. The request is received by the integration platform 20 and is converted to a business object by the request interpretation component 27. The business object is then sent to the patient intake module 22 (not shown), which is configured to process the request for physical therapy services. The processing of the business object generates a workflow that raises a workflow processing event that is processed by the operations module 22 using one of the business workflow rules 23 to assign an appropriate physical therapist to the patient.

The physical therapist is selected based on the physical therapist's experience and skill level as compared to the patient's medical conditions as indicated by the patient data. Each clinician and member of the home healthcare team uses a personal assistant application 12 that is configured to enable that user to self-schedule availability for appointments, patient visits, meetings, and the like. As part of the clinician-assignment process, the operations module 22 processes integrated information to determine the clinician's availability to service the patient. Upon assignment, the clinician can self-schedule patient appointments using the personal assistant application 12. The personal assistant application 12 is also used to record mileage traveled from the clinician's starting point to the patient's point of delivery of the service. Mileage and other expenses that the clinician incurs as a result of providing the service to the patient are submitted by the personal assistant application 12 to calculate payroll and approved reimbursements.

The delivery of the physical therapy services to the patient are documented when the clinician submits data via the point of care application 13. The clinician submits data related to the home healthcare visit, such as which physical therapy services were performed, patient's progress since the last visit if the visit is not an initial visit, medical information related to the patient such as vital signs and the like. The clinician can access reference tools such as the visit validation tab or the compliance tab to confirm that the physical therapy service provided is appropriate and complies with Medicare conditions of participation.

The integration platform receives the data submitted via the point of care application 13 and are converted to a business object using the request interpretation component. The business object is sent to the electronic medical record module that processes the business object to create and store clinical documents, physician orders, patient schedule, status history, and triggers workflow actions to be taken.

The processing of the business object described above generates a workflow that raises a workflow processing event. The workflow is sent to the quality control module 22 for processing to confirm that data submitted by the clinician are accurate, complete, and comply with regulatory requirements.

In parallel, workflow is also sent to the marketing module 22, which tracks who referred the patient to the home health service for physical therapy and other information related to the business of running a home healthcare service.

The applications platform 10 in this example also has a third party portal (not shown) that is configured to enable the patient's children, who the patient has designated to be authorized users, to view the data stored in the system to monitor the patient's status, progress, and physical therapy schedule.

### Example 2

### Patient Location

In this example, the system 100 is used to increase efficiency in home healthcare delivery by processing a request and simultaneously identifying an appropriate care provider. In this way the system 100 can minimize travel time and distance to the patient location, maximize utilization of salaried versus per diem labor, and efficiently manage active patient caseload per employee. Traditional systems manage coordination of patient care by assigning each clinician a large coverage area, requiring office employees to print reports containing data related to providing the service to each patient, and assigning clinicians to care for patients by cross referencing the service coverage area report with the patients' location.

In this example, the clinician is a nurse and the home healthcare service is geriatric care. The integration platform 20 receives the request to assign a nurse to provide the service, including information about the patient's location, and is converted to a business object by the request interpretation component 27. The business object is then sent to the operations module 22, which is configured to process the request to assign a nurse to provide the service to the patient. The processing of the business object generates a workflow that raises a workflow processing event that is processed by the operations module 22 using one of the business workflow rules 23 to identify a nurse who is qualified to provide geriatric care and who works or resides close to the patient.

The workflow event processes data retrieved from at least one of the storage devices, including:
patient demographics, including patient location;
clinician demographics, including employment status (salaried versus per diem) and clinician location (residential or employment); and
facility data (such as the level of care provided by the facility).
   The operations module 22 processes these retrieved data to identify a nurse who is qualified to provide geriatric care and who lives or works in close proximity to the patient, and to check the nurse's schedule to notify her of an appointment with the patient. The operations module 22 uses a business workflow rule 23 to apply weighted mathematical algorithms to the business objects to build a ranking system of clinicians best suited to care for a given patient. The ranking is built from data inputted into the system via at least one of the applications comprising the applications platform 10.

After the homecare visit takes place, the nurse enters data summarizing and reporting on the homecare visit via the point of care application 13. The integration platform receives the request to store data from the application 13 and the request interpretation component 27 converts the request to a business object. The business object is then sent to the medical record module for processing and data are stored in at least one of the storage databases 31.

### Example 3

### Physician Order Processing

Efficient tracking and processing of physician orders is critical to cash flow in the home health care industry. Payment cannot be requested until all verbal physician orders are signed by the physician. The system 100 eliminates the delays of the traditional system by automatically generating workflow that makes a signed physician order available to all authorized users who need to know that the order has been signed, including billing personnel, who can then close the chart for billing purposes.

In this example, data related to patient care are submitted via the point of care application 13 and are received by the integration platform 20. The request interpretation component 27 converts the data to a business object and the data are processed using operations module 22 and then a quality review module 22, sequentially. The processing of the data generates workflow which raises a workflow processing event that is processed using workflow rules 23 to generates a plan of care order requiring signature from a physician. This order is instantly delivered for the physician's signature. Pending orders are monitored by the system 100 based upon a configured set of business workflow rules 23 to identify which may require additional follow-up. When signed orders are received, the integration platform 20 captures the signed order and if the chart is closed and ready for billing the patient is passed transparently to the billing module.

### Example 4

### New Clinician Hire

In this example, a new clinician is hired. Demographic information about the clinician, including areas of specialty, skill level, experience, residential data, and the like, are entered via the web application. The integration platform 20 receives the request to enter data about the new hire, and the request interpretation component 27 converts the request to a business object. The data are processed by the human resources module and are stored in one of the storage devices. An application response is generated that confirms that the data have been entered and that the new hire is entered as an employee, the response is formatted by the response formatting component 28, and the response is sent to the web application 11.

The request generates workflow that alerts the payroll department and the employee's supervisor that the employee has been added to the system. The workflow is processed using the payroll module (not shown) to attach payroll information to the employee based upon the employee's location, and to pass the newly added employee to the payroll department to verify the information required to include the employee in the payroll process. The workflow result results are saved in one of the storage databases 31 and payroll is automatically notified that the employee this task has been completed.

Simultaneously or sequentially, the workflow processing also alerts the new employee's supervisor that the employee has been added to the system. The supervisor can then begin to schedule orientation preceptorship for the new hire.

We claim:

1. A computer-implemented method for managing and delivering workflow to a home healthcare service, said method comprising the steps of:
a. receiving a request from an application configured to communicate with an integration platform, said integration platform comprising a request interpretation component configured to use logic rules to convert said request to a standard format, at least one module configured to process said standard format request to generate a response, and to further process a workflow resulting from said response or said standard format request, and a response formatting component configured to use logic rules to convert said response to a format that a requesting application is configured to understand;
b. converting said request to said standard format using said request interpretation component;
c. processing said converted request using at least one of said logic rules to generate said response to said request, wherein said processing generates said workflow;
d. converting said response to said format that said requesting application is configured to understand using said response formatting component; and
e. processing said workflow using at least one workflow rule to generate at least one workflow result, and to make said workflow and said workflow result available to at least one authorized user.

2. The method of claim 1 wherein said step of processing said converted request comprises at least one of the steps of storing data in a storage platform and retrieving data from said storage platform.

3. The method of claim 1 further comprising the step of automatically generating an instruction to use said workflow to provide home healthcare to a patient.

4. The method of claim 1 further comprising the step of storing at least one of said workflow and said workflow result in said storage platform.

5. The method of claim 1 further comprising the step of notifying an authorized user about at least one of said workflow or said workflow result.

6. The method of claim 1 wherein said request is at least one of a request for processing at least one piece of data, a request for storing at least one piece of data, and a request for retrieving at least one piece of data.

7. The method of claim 1 wherein said workflow is at least one alert that is automatically generated in response to said request.

8. An integrated business management system for managing workflow for a home healthcare service in response to requests executed by a user or automated by workflow rules, the system comprising:
a. a processing interface configured to communicate with and receive a request from an application, said interface comprising:
i. a request interpretation component configured to convert said request to a standard format; and
ii. a response formatting component configured to convert a response to a format that a requesting application is configured to understand;
b. at least one module configured to process said request to generate a response, and to further process a workflow resulting from said response or said request to generate a workflow result; and
c. a storage platform comprising at least one storage device configured to store said request, said workflow, and said workflow result that communicates with said at least one module.

9. The system of claim 8 wherein said at least one module is selected from the group consisting of an operations module, an electronic medical record module, a quality module, a billing module, and a marketing module.

10. The system of claim 8 wherein system said request generates a workflow process that requires processing by another module.

11. The system of claim 8 wherein said application is selected from the group consisting of a web application, a personal assistant application, and a point of care application.

12. The method of claim 8 wherein said request for processing at least one piece of data, a request for storing at least one piece of data, and a request for retrieving at least one piece of data.

13. The method of claim 8 wherein said workflow is at least one alert that is automatically generated in response to said request.

14. An apparatus for managing and delivering workflow to a home healthcare service, comprising:
a. means for receiving a request from an application configured to communicate with an integration platform, said integration platform comprising a request interpretation component configured to convert said request to a standard format, at least one module configured to process said request to generate a response, and to further process a workflow resulting from said response or said request, and a response formatting component configured to convert said response to a format that a requesting application is configured to understand;
b. means for converting said request to said standard format using said request interpretation component;
c. means for processing said converted request to generate said response, wherein said processing generates said workflow;
d. means for converting said response to said format that said requesting application is configured to understand using said response formatting component; and
e. means for processing said workflow using at least one workflow rule to generate at least one workflow result, and to make said workflow and said workflow result available to at least one authorized user.

15. The apparatus of claim 14 further comprising at least one of means for storing data in a storage platform, means for retrieving data from said storage platform, and means for storing said business workflow in said storage platform.

16. The apparatus of claim 14 further comprising means for notifying an authorized user about said workflow and said workflow result.

17. The apparatus of claim 14 wherein said request is at least one of a request for processing at least one piece of data, a request for storing at least one piece of data, and a request for retrieving at least one piece of data.

18. The said apparatus of claim 14 wherein said workflow is at least one alert that is automatically generated in response to said request.

19. A computer-readable medium having stored therein instructions which, when executed by a processor, cause the processor to:
a. receive a request from an application configured to communicate with an integration platform, said integration platform comprising a request interpretation component configured to convert said request to a standard format at least one module configured to process said request to generate a response, and to further process a workflow resulting from said response or said request, and, a response formatting component configured to convert said response to a format that a requesting application is configured to understand, and a response formatting component configured to convert said response to a format that a requesting application is configured to understand;
b. convert said request to said standard format using said request interpretation component;
c. process said converted request to generate said response to said request, wherein said processing generates said workflow;
d. convert said response to said format that said requesting application is configured to understand using said response formatting component;
e. process said workflow using at least one workflow rule to generate at least one workflow result, and to make said workflow and said workflow result available to at least one authorized user.

20. The method of claim 19 wherein said workflow is at least one alert that is automatically generated in response to said request.
